(19) United States
(12) Patent Application Publication
(10) Pub. No.: US 2026/0201648 A1
(43) Pub. Date: Jul. 16, 2026

(54) TENSILE DEGRADABLE ENVIRONMENT-FRIENDLY FIBER-SANDWICHED KRAFT PAPER ADHESIVE TAPE AND MANUFACTURING PROCESS THEREFOR

(71) Applicant: FUJIAN JIALONG ADHESIVE TAPE CO.,LTD., Zhangzhou (CN)

(72) Inventor: Benyu HUANG, NINGDE (CN)

(73) Assignee: FUJIAN JIALONG ADHESIVE TAPE CO.,LTD., Zhangzhou (CN)

(21) Appl. No.: 19/019,091

(22) Filed: Jan. 13, 2025

(51) Int. Cl. D21H 19/84; B32B 3/08; B32B 29/00; B32B 37/12; B32B 37/24; C09J 7/29; C09J 7/35; D21H 11/04; D21H 27/00

(52) U.S. Cl. CPC D21H 19/84; B32B 3/085; B32B 29/005; B32B 37/1284; B32B 37/24; C09J 7/29; C09J 7/35; D21H 11/04; D21H 27/00; B32B 2037/243; B32B 2255/12; B32B 2255/26; B32B 2255/28; B32B 2262/06; B32B 2307/716; B32B 2309/02; B32B 2317/122; B32B 2405/00; C09J 2301/16; C09J 2301/304

(57) ABSTRACT

The present invention relates to the field of binding adhesive tapes, and more particularly, to a tensile degradable environment-friendly fiber-sandwiched kraft paper adhesive tape and a manufacturing process therefor. Wherein the kraft paper adhesive tape includes a kraft paper layer and an adhesive layer, and a reinforcing layer provided on the kraft paper layer. The kraft paper layer is formed by stacking at least two layers of kraft paper, and the reinforcing layer is provided between two adjacent layers of kraft paper of the kraft paper layer. The reinforcing layer includes several yarns, and the yarns are adhered in the kraft paper layer by a composite glue, so that a fiber-sandwiched structure composed of yarns is formed in the kraft paper layer, which can improve the structural stability, the tensile and tearing strength of the kraft paper adhesive tape. In addition, it is advantageous for environmental protection.

### TECHNICAL FIELD

The present invention relates to the field of adhesive tapes, and more particularly, to a tensile degradable environment-friendly fiber-sandwiched kraft paper adhesive tape and a manufacturing process therefor.

### BACKGROUND

The adhesive tape can be easily bonded when using a small pressure, can play a bonding effect in a short time, does not contaminate the adherend after peeling, and can be re-corrected when being misplaced. Taking a kraft paper adhesive tape as an example, the kraft paper adhesive tape uses kraft paper as base material, and glue is applied on one side of the kraft paper to form a strong adhesive tape.

However, the current kraft paper adhesive tape, which has only one layer of kraft paper as a base material, has poor tensile and tearing strength and is easily broken. In addition, with the rise of online shopping and the express industry, due to the poor tear resistance of kraft paper adhesive tape, a large number of express boxes use OPP adhesive tape, while OPP adhesive tape uses polypropylene film as base material, which is basically non-recyclable and non-degradable, which is not conducive to environmental protection.

### SUMMARY

In response to the above-mentioned deficiencies of the background art, the present invention provides a tensile degradable environment-friendly fiber-sandwiched kraft paper adhesive tape and manufacturing process therefor.

The present invention adopts the following technical solution:

In a first aspect, a tensile degradable environment-friendly fiber-sandwiched kraft paper adhesive tape, wherein the kraft paper adhesive tape comprises a kraft paper layer and an adhesive layer, and a reinforcing layer provided in the kraft paper layer; wherein,
the kraft paper layer is formed by stacking at least two layers of kraft paper, and the reinforcing layer is provided between two adjacent layers of kraft paper of the kraft paper layer;
the adhesive layer is a starch glue or a hot melt glue;
the reinforcing layer comprises several yarns adhered in the kraft paper layer, and the kraft paper layer distributes 1 to 10 yarns per 10 mm of width.

In a possible embodiment of the first aspect, when the adhesive layer is a hot melt glue, a release agent layer, and a primer agent layer are sequentially provided on the side of the kraft paper layer facing away from the adhesive layer.

In a possible embodiment of the first aspect, the release agent layer comprises an aqueous release agent coated on the surface of the primer agent layer.

In a possible embodiment of the first aspect, the primer agent layer comprises an anti-penetration aqueous primer agent coated on the surface of the kraft paper layer.

In a possible embodiment of the first aspect, the yarns are distributed in parallel or S-bend along the length extension direction of the kraft paper layer.

In a second aspect, the present invention provides a manufacturing process for the kraft paper adhesive tape described above, the process comprising the following steps:
S1: drawing two layers of kraft paper and yarns into a compounding device, respectively, and the two layers of kraft paper being respectively located above and below the yarns; before entering the compounding device, the yarns being immersed in a composite glue, and both sides of the two layers of the kraft paper facing the yarn being coated with the composite glue;
S2: the kraft paper and the yarns entering the compounding device, the compounding device heating the composite glue to melt the composite glue, and pressing two layers of the kraft paper and the yarns together, so that the composite glue compounding the kraft paper and the yarns, and combining the two layers of the kraft paper to form the kraft paper layer, and the yarns forming a reinforcing layer sandwiched in the kraft paper layers;
S3: adhesive layer, after compounding the kraft paper layers, coating an adhesive layer on one side of the kraft paper layer by a second coater to form the adhesive layer;
S4: after drying, and rolling, to obtain the fiber-sandwiched kraft paper adhesive tape.

In a possible embodiment of the second aspect, in step S3, when the adhesive layer coated on one side of the kraft paper layer by the second coater is a hot melt glue, the other side of the kraft paper layer is sequentially coated with a layer of anti-penetration aqueous agent and a layer of aqueous release agent by the third coater and the fourth coater.

In a possible embodiment of the second aspect, when the kraft paper and the yarns of step S2 are compounded in a compounding device, the kraft paper and the yarns pass between two heat-conducting rollers of the compounding device, and the temperature of the two heat-conducting rollers is 65-150° C.

In a possible embodiment of the second aspect, after coating the composite glue on one side of the kraft paper, the starch glue on the kraft paper is preheated at a preheating temperature of 50-60° C. before entering the compounding device.

In a possible embodiment of the second aspect, in step S1, the yarns are immersed into the composite glue in such a manner that the composite glue is poured into a container, and the container is heated to prevent the composite glue from solidifying; and a plurality of guide wheels are arranged in the container, and the yarns are drawn into the container along the guide wheels and then drawn out of the container.

It can be seen from the above description of the present invention that the present invention has the following advantages over the prior art: the present invention is to compositely join a reinforcing layer made of yarns in a kraft paper layer so as to sandwich the kraft paper layer to form a fiber-sandwich made of yarns, and this structure can improve the structural stability of the kraft paper adhesive tape, making it difficult to break and deform, thereby improving the tensile and tearing strength of the kraft paper adhesive tape. In addition, the kraft paper layer and the reinforcing layer as the base material of the present invention are easily degradable materials, so that the kraft paper adhesive tape of the present invention can be degraded, which is advantageous for environmental protection.

### BRIEF DESCRIPTION OF DRAWINGS

FIG. 1 is a cross-sectional schematic view of a kraft paper adhesive tape of the present invention when the adhesive layer is a starch glue.

FIG. 2 is a cross-sectional schematic view of the kraft paper adhesive tape of the present invention when the adhesive layer is a hot melt glue.

FIG. 3 is a schematic view showing the parallel distribution of yarns on the kraft paper layer in the kraft paper adhesive tape of the present invention.

FIG. 4 is a schematic view showing an S-shaped distribution of yarns on a kraft paper layer in the kraft paper adhesive tape of the present invention.

FIG. 5 is a schematic view of a kraft paper adhesive tape of the present invention during a draw-compounding process.

### DETAILED DESCRIPTION OF THE EMBODIMENTS

In order that the objects, aspects, and advantages of the present application will become more apparent, a more particular description of the present application will be rendered by reference to the appended drawings.

In the following, the terms “first”, “second”, and the like are used for descriptive purposes only and are not to be construed as indicating or implying relative importance or implicitly indicating the number of technical features indicated. Thus, a feature defined as “first”, “second”, etc. may explicitly or implicitly comprise one or more of the feature. In the description of the present application, unless otherwise indicated, the meaning of “a plurality of” is two or more.

Further, in this application, directional terms such as “upper”, “lower”, and the like are defined with respect to the orientation in which components are schematically illustrated in the drawings, and it is to be understood that such directional terms are relative terms used for descriptive purposes and clarity and may vary accordingly depending upon the orientation in which the components are illustrated in the drawings.

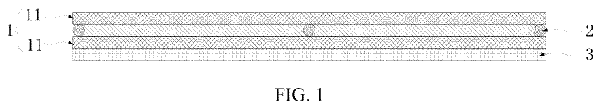

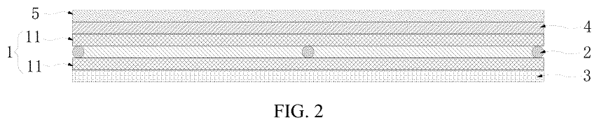

The present invention provides invention, there is provided a tensile degradable environment-friendly fiber-sandwiched kraft paper adhesive tape, as shown in FIG. 1, comprising a kraft paper layer 1 and an adhesive layer 3, and a reinforcing layer 2 provided on the kraft paper layer 1. Wherein the kraft paper layer 1 is formed by stacking at least two layers of kraft paper, and a reinforcing layer 2 is provided between two adjacent layers of kraft paper of the kraft paper layer 1. The reinforcing layer 2 comprises several yarns 21, wherein the yarns may be easily degradable materials such as plant fiber yarns, and the yarns 21 are attached in the kraft paper layer 1 by means of a composite glue, preferably an adhesive or a hot melt glue. The adhesive layer 3 is arranged on one side of the kraft paper layer 1, and the adhesive layer 3 is a starch glue or a hot melt glue; when the adhesive layer 3 is a hot melt glue, as shown in FIG. 2, a release agent layer 5 and a primer agent layer 4 are successively arranged on the side of the kraft paper layer 1 facing away from the adhesive layer 3.

The release agent layer 5 includes an aqueous release agent coated on the surface of the primer agent layer 4 to prevent the adhesive tape from sticking during the attaching process and to ensure the adhesive property and service life of the adhesive tape. The primer agent layer 4 comprises an anti-penetration aqueous primer agent coated on the surface of the kraft paper layer 1, so as to prevent the penetration of water, protect the use effect of the adhesive tape in a humid environment, and prevent the penetration of water through the adhesive tape to the surface of the adherend, thereby extending the service life of the adhesive tape. In addition, when the adhesive layer 3 is a hot melt glue, the adhesive layer 3 is preferably a degradable polymer as a matrix resin, such as polyesters, polyurethanes, etc. so as to achieve a similar performance with the existing adhesives and at the same time have good biodegradability, which helps to reduce the pollution of the hot melt glue to the environment during the production and use.

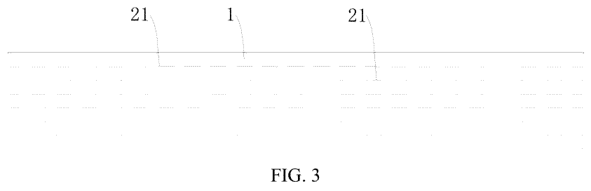

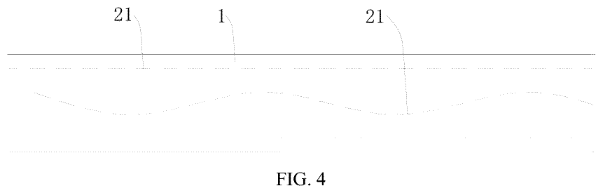

The kraft paper layer 1 preferably has 1 to 10 yarns 21 distributed per 10 mm of width, the yarns 21 being distributed in parallel along the length extension direction of the kraft paper layer 1 as shown in FIG. 3, or the yarns 21 being distributed in a continuous s-bend along the length extension direction of the kraft paper layer 1 as shown in FIG. 4. The tensile and tearing strength of the kraft paper adhesive tape can be improved by the distribution structure of the yarns 21, and at the same time, it is not easy to break, which is beneficial to enhance the service life of the kraft paper adhesive tape.

Preferably, the starch glue used as the adhesive layer 3 comprises, in parts by weight: deionized water 15-18 parts, starch 9-12 parts, photocatalyst 0.06-0.1 parts, defoamer 0.04-0.06 parts and plasticizer 0.05-0.08 parts. Wherein the starch may be a plant starch, preferably corn starch; the photocatalyst is titanium dioxide powder.

In addition, the method for preparing the starch glue in the present embodiment may include the following steps:
S1: the starch and deionized water were stirred until uniformly mixed according to the parts by weight of each component in the above-mentioned starch glue to form a starch slurry, then an amylase was added to the starch slurry in parts by weight of 1000 parts of the starch slurry and 2-2.5 parts of the amylase to continue stirring, and the starch slurry was simultaneously heated to 100-120° C., and after cooling, a water-soluble starch paste could be obtained;
S2: the starch paste obtained in step S1 was heated to 100-220° C., and then a photocatalyst, a defoamer, and a plasticizer were added, the mixture was stirred for 30 min, and then naturally cooled to 30-60° C. to obtain a starch glue.

It can be seen from the above that the starch glue is based on starch and has an easy degradation effect, so that the kraft paper adhesive tape of the present invention can be more easily degraded after use, at the same time, the kraft paper layer 11 and the reinforcing layer 22 can be completely degraded after being attacked by organisms in nature (such as bacteria, fungi or algae), and are finally metabolized into water and carbon dioxide by enzymes. However, in order to further promote the degradation, in the present invention, titanium dioxide-based photocatalyst can also be added to the starch glue and the composite glue, and after absorbing light energy, the photocatalyst can directly perform oxidation and reduction on the object adsorbed on the surface, or oxidize hydroxyl radicals (OH—) adsorbed on the surface to generate strong oxidative hydroxyl radicals (—OH), and oxidize the object, which is equivalent to the efficiency of promoting the degradation of the kraft paper adhesive tape.

In addition, since the composition of the yarns 21 of the reinforcing layer 2 corresponds to a height difference from that of the kraft paper layer 1, the formation of bubble holes between the yarns 21 and the kraft paper layer 1 during the roll-compounding of the starch glue can be avoided by adding a defoamer to the starch glue, which helps to improve the adhesion of the starch glue to the kraft paper layer 1 and the reinforcing layer 2, respectively.

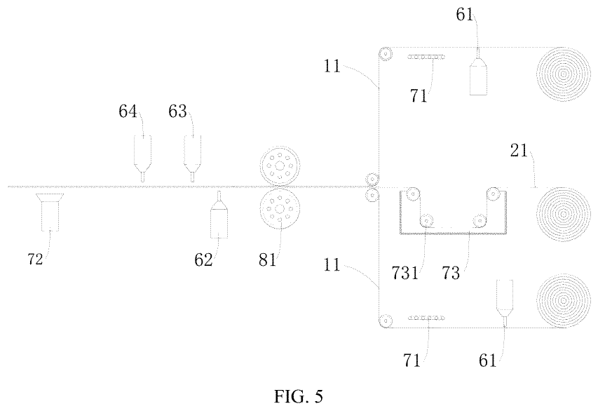

The present invention also provides a process for preparing the above-mentioned kraft paper adhesive tape, as shown in FIG. 5, the manufacturing process comprises the following steps:
S1: the kraft paper and the yarns 21 are respectively on a drawing device, which may be a cloth drawing device, by means of which two layers of kraft paper and the yarn 21 are respectively drawn into the compounding device, and the two layers of kraft paper are respectively located above and below the yarn 21; before entering the compounding device, the yarns 21 are immersed in the composite glue, and the way of immersion can be pouring the composite glue into a container 73, wherein the container 73 is maintained in a heated state to prevent the composite glue from solidifying, and a plurality of guide wheels 731 are provided in the container 73, so that the yarns 21 pass around the guide wheels 731 and is drawn into the container 73 along the guide wheels 731 and is then drawn out from the container 73, thereby achieving the function of wrapping the composite glue on the surface of the yarns 21;
at the same time, two first coaters 61 are used to coat the composite glue on one side of the two kraft paper layers 1 facing the yarns 21, and then the composite glue is preheated, the preheating temperature being 50-150° C., and the preheating method may be that a baking device 71 made of an electric heating tube is provided at the position where the kraft paper is pulled through, thereby forming a high-temperature environment to preheat the composite glue on the reinforcing layer 2;
S2: The compounding device heats the composite glue via two heat-conducting rollers 81 so that the composite glue melts and the kraft paper layer 1 and the yarns 21 are compounded; during the compounding, the kraft paper and the reinforcing layer 2 pass between two heat-conducting rollers 81, the temperature of the two heat-conducting rollers 81 is 65-150° C., so that the two heat-conducting rollers 81 perform secondary heating on the composite glue, and in the process, the heat-conducting rollers 81 of the compounding device can rapidly heat the composite glue to a gelatinization temperature through the above-mentioned pre-heating, so as to facilitate pressing the kraft paper and the yarns 21 into a forming type so that each kraft paper is compounded to form a kraft paper layer 1, the yarns 21 form a reinforcing layer 22, and a structure in which the reinforcing layer 2 is sandwiched in the kraft paper layer 1 is formed;

S3: One side of the kraft paper layer 1 formed by the compounding of the heat-conducting rollers 81 is coated with a layer of adhesive glue by a second coater 62, wherein the adhesive glue forms an adhesive layer 3, and the adhesive glue can be a starch glue or a hot melt glue; furthermore, when the adhesive glue coated on one side of the kraft paper layer 1 by the second coater 62 is a hot melt glue, the other side of the kraft paper layer 1 is successively coated with a layer of an anti-penetration aqueous primer agent and a layer of an aqueous release agent by a third coater 63 and a fourth coater 64;

S4: After drying, and rolling, the fiber-sandwiched kraft paper adhesive tape can be obtained, wherein the drying can be by blowing hot air in the direction below the kraft paper layer 1 by means of a hot air fan 72, the temperature of the hot air being 32-80° C., preferably 35° C., which temperature range is lower than the gelatinization temperature of the starch glue and the hot melt glue, thereby achieving rapid drying while avoiding the gelatinization of the adhesive layer 3.

It can be seen from the above-mentioned process that in the process of compound forming the kraft paper adhesive tape according to the present invention, by drawing the kraft paper and the yarns 21 successively through each process, one-time compound forming of the kraft paper adhesive tape can be completed, and no need to migrate to other positions for secondary processing, which is very simple and helps to improve the production efficiency. In addition, in the present invention, by compounding a reinforcing layer 2 made of yarns 21 into the kraft paper layer 1, the structural stability of the kraft paper adhesive tape can be improved, the deformation of the kraft paper adhesive tape is not easy, and the tensile and tearing strength of the kraft paper adhesive tape can be improved by sandwiching the kraft paper layer 1 with the fiber-sandwich made of yarns 21. When the kraft paper adhesive tape of the present invention is attached to an express box, it is difficult to completely tear it off, and the complete kraft paper adhesive tape is damaged by forceful tearing, thereby preventing the kraft paper adhesive tape from being maliciously torn by others, thereby preventing theft. At the same time, the material of the present invention uses kraft paper as a degradable material, and the composite glue used for bonding the kraft paper layer 1 and the reinforcing layer 2 is composed of a degradable adhesive or hot melt glue, and the adhesive layer 3 is also a degradable hot melt glue or starch glue as a base material. It can be seen therefrom that the kraft paper adhesive tape of the present invention uses a material which is easily degraded, and thus can be degraded to facilitate environmental protection.

While the foregoing is directed to embodiments of the present invention, other and further embodiments of the invention may be devised without departing from the basic scope thereof, and the scope thereof is determined by the claims that follow.

What is claimed is:

1.A tensile degradable environment-friendly fiber-sandwiched kraft paper adhesive tape, wherein the kraft paper adhesive tape comprises a kraft paper layer and an adhesive layer, and a reinforcing layer provided in the kraft paper layer; wherein,
the kraft paper layer is formed by stacking at least two layers of kraft paper, and the reinforcing layer is provided between two adjacent layers of kraft paper of the kraft paper layer;
the adhesive layer is a starch glue or a hot melt glue;
the reinforcing layer comprises several yarns adhered in the kraft paper layer, and the kraft paper layer distributes 1 to 10 yarns per 10 mm of width.

2.The kraft paper adhesive tape of claim 1, wherein, when the adhesive layer is a hot melt glue, a release agent layer and a primer agent layer are sequentially provided on the side of the kraft paper layer facing away from the adhesive layer.

3.The kraft paper adhesive tape of claim 2, wherein the release agent layer comprises an aqueous release agent coated on the surface of the primer agent layer.

4.The kraft paper adhesive tape of claim 2 wherein the primer agent layer comprises an anti-penetration aqueous primer agent coated on the surface of the kraft paper layer.

5.The kraft paper adhesive tape of claim 1, wherein the yarns are distributed in parallel or S-bend along the length extension direction of the kraft paper layer.

6.A manufacturing process for the kraft paper adhesive tape of any one of claims 1 to 5, comprising the following steps:
S1: drawing two layers of kraft paper and yarns into a compounding device, respectively, and the two layers of kraft paper being respectively located above and below the yarns; before entering the compounding device, the yarns being immersed in a composite glue, and both sides of the two layers of the kraft paper facing the yarn being coated with the composite glue;
S2: the kraft paper and the yarns entering the compounding device, the compounding device heating the composite glue to melt the composite glue, and pressing two layers of the kraft paper and the yarns together, so that the composite glue compounding the kraft paper and the yarns, and combining the two layers of the kraft paper to form the kraft paper layer, and the yarns forming a reinforcing layer sandwiched in the kraft paper layers;
S3: adhesive layer, after compounding the kraft paper layers, coating an adhesive layer on one side of the kraft paper layer by a second coater to form the adhesive layer;
S4: after drying, and rolling, to obtain the fiber-sandwiched kraft paper adhesive tape.

7.The manufacturing process of claim 6, wherein in step S3, when the adhesive layer coated on one side of the kraft paper layer by the second coater is a hot melt glue, the other side of the kraft paper layer is sequentially coated with a layer of anti-penetration aqueous agent and a layer of aqueous release agent by the third coater and the fourth coater.

8.The manufacturing process of claim 6, wherein, when the kraft paper and the yarns of step S2 are compounded in a compounding device, the kraft paper and the yarns pass between two heat-conducting rollers of the compounding device, and the temperature of the two heat-conducting rollers is 65-150°C.

9.The manufacturing process of claim 6, wherein, after coating the composite glue on one side of the kraft paper, the composite glue on the kraft paper is preheated at a preheating temperature of 50-150°C. before entering the compounding device.

10.The manufacturing process of claim 6, wherein in step S1, the yarns are immersed into the composite glue in such a manner that the composite glue is poured into a container, and the container is heated to prevent the composite glue from solidifying; and a plurality of guide wheels are arranged in the container, and the yarns are drawn into the container along the guide wheels and then drawn out of the container.
